(19) United States
(12) Patent Application Publication
(10) Pub. No.: US 2021/0026923 A1
(43) Pub. Date: Jan. 28, 2021

(54) Intent-Based Language Translation

(71) Applicant: Reginald Dalce, Boynton Beach, FL (US)

(72) Inventor: Reginald Dalce, Boynton Beach, FL (US)

(21) Appl. No.: 16/519,838

(22) Filed: Jul. 23, 2019

(51) Int. Cl. G06F 17/28; G10L 15/00

(52) U.S. Cl. CPC G06F 17/289; G10L 15/005

(57) ABSTRACT

The present inventive concept contemplates a system or method of translating a user's voice and intent into a different language. The method contemplates extracting the objectives of a first voice input and translating those objectives to a different language with different vocal characteristics. Vocal characteristics comprise any facet of communicative expression associated with an objective.

### FIELD OF THE INVENTION

The field of the invention is language translation.

### BACKGROUND

The following description includes information that may be useful in understanding the present invention. It is not an admission that any of the information provided in this application is prior art or relevant to the presently claimed invention, or that any publication specifically or implicitly referenced is prior art.

There are instances in the prior art describing the use of captured images in PCT Patent Application No. US 2004/013366 to Cutaia. Cutaia discloses a method of storing different speech vectors associated with different speakers and different translations. However, Cutaia fails to consider the differences between cultural expressions of emotions and their associated unique vocal characteristics.

U.S. Pat. No. 7,437,704 to Dahne-Stuber discloses a real-time software translation method that translates text to a different language to localize the software content in real-time such that post-release localization and its accompanying delays are unnecessary. However, Dahne-Stuber fails to contemplate the complexities of translating spoken language in real-time while translating the intent behind a statement in one language to another, which can require various vocal characteristics to be translated differently in different languages rather than simple mirroring. For example, anger in American-English can be expressed with different intonation and pacing than a speaker would use in Japanese.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply. In this patent application, a camera is installed on a person or a object, and captured images by the camera were sent to and viewed by mobile phones and/or computers owned by the third party.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their end points, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need to translate vocal characteristics associated with a translation to accurately reflect the intent of the original statement.

### SUMMARY OF THE INVENTION

The inventive subject matter provides apparatus, systems and methods for translating the voice content and vocal characteristics of a voice input to a translated voice content and vocal characteristics.

The methods herein contemplate translating content and meaning of a voice input in a first language into a second language. The content and meaning of a voice input are translated by analyzing and determining the voice input content and associated vocal characteristics. The invention herein further contemplates extracting an objective of the voice input content and vocal characteristics within the context of the first language. Based on the extracted objectives and vocal characteristics, a second set of vocal characteristics and voice input content associated with the second language is determined. The original voice input is then converted to the second language with corresponding vocal characteristics that convey the meaning behind the original voice input. It is important to note that the vocal characteristics of the second language to convey a particular emotion can be different from the vocal characteristics for the first language for the same emotion.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a functional block diagram illustrating a distributed data processing environment.

FIG. 2 is a schematic of a method of extracting objectives from a voice input.

FIG. 3 depicts a method for translating a voice input and extracted objectives to a different language with different vocal characteristics.

FIG. 4 depicts a block diagram of components of the server computer executing translation engine 110 within the distributed data processing environment of FIG. 1.

### DETAILED DESCRIPTION

It should be noted that while the following description is drawn to a computer-based imaging system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the inventive subject matter provides a system or method that allows users to view images captured by a worn camera by use of a mobile phone and/or a computer. Some aspects of the inventive subject matter include a method of providing a system that enables people (e.g., the third party) to view environment surrounding the person at real-time and/or later, and/or to select the visible focusing range and the range of visible wavelength which are in the range of human eyes, such that expanding the sight capability.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

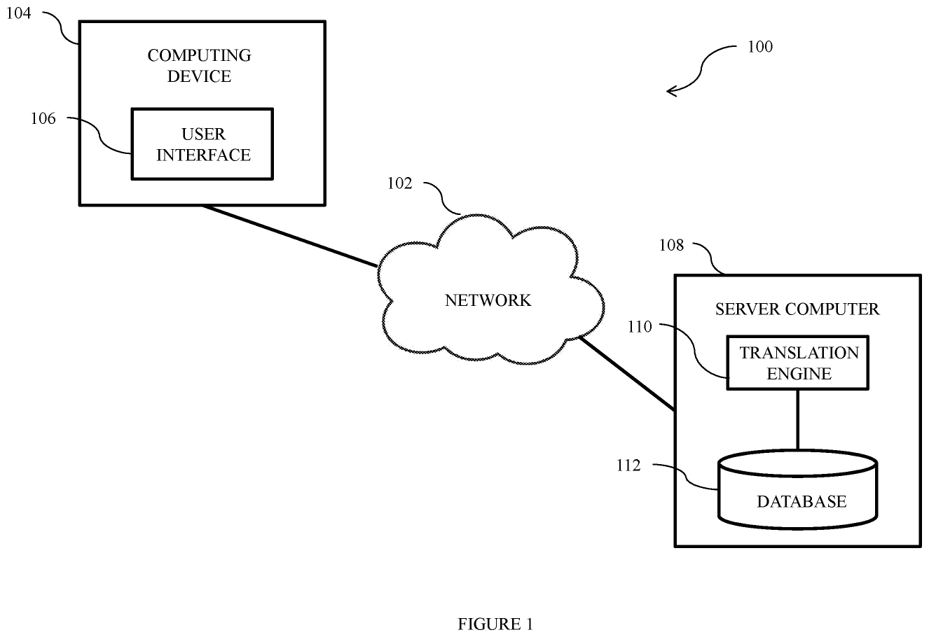

FIG. 1 is a functional block diagram illustrating a distributed data processing environment.

The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes held camera 104, worn camera 114, and server computer 108, interconnected over network 102. Network 102 can include, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between held camera 104, server computer 108, and any other computing devices (not shown) within distributed data processing environment 100.

It is contemplated that held computing device 104 can be any programmable electronic computing devices capable of communicating with various components and devices within distributed data processing environment 100, via network 102. It is further contemplated that computing device 104 can execute machine readable program instructions and communicate with any devices capable of communication wirelessly and/or through a wired connection. As depicted, computing device 104 includes an instance of user interface 106. However, it is contemplated that any electronic device mentioned herein can include an instance of user interface 106.

User interface 106 provides a user interface to translation engine 110. Preferably, user interface 106 comprises a graphical user interface (GUI) or a web user interface (WUI) that can display one or more of text, documents, web browser windows, user option, application interfaces, and operational instructions. It is also contemplated that user interface can include information, such as, for example, graphics, texts, and sounds that a program presents to a user and the control sequences that allow a user to control a program.

In some embodiments, user interface can be mobile application software. Mobile application software, or an “app,” is a computer program designed to run on smart phones, tablet computers, and any other mobile devices.

User interface 106 can allow a user to register with and configure translation engine 110 (discussed in more detail below) to enable a user to access a mixed reality space. It is contemplated that user interface 106 can allow a user to provide any information to translation engine 110.

Server computer 108 can be a standalone computing device, a management server, a web server, a mobile computing device, or any other computing system capable of receiving, sending, and processing data.

It is contemplated that server computer 108 can include a server computing system that utilizes multiple computers as a server system, such as, for example, a cloud computing system.

In other embodiments, server computer 108 can be a computer system utilizing clustered computers and components that act as a single pool of seamless resources when accessed within distributed data processing environment 100.

Database 112 is a repository for data used by translation engine 110. In the depicted embodiment, translation engine 110 resides on server computer 108. However, database 112 can reside anywhere within a distributed data processing environment provided that translation engine 110 has access to database 112.

Data storage can be implemented with any type of data storage device capable of storing data and configuration files that can be accessed and utilized by server computer 108. Data storage devices can include, but are not limited to, database servers, hard disk drives, flash memory, and any combination thereof

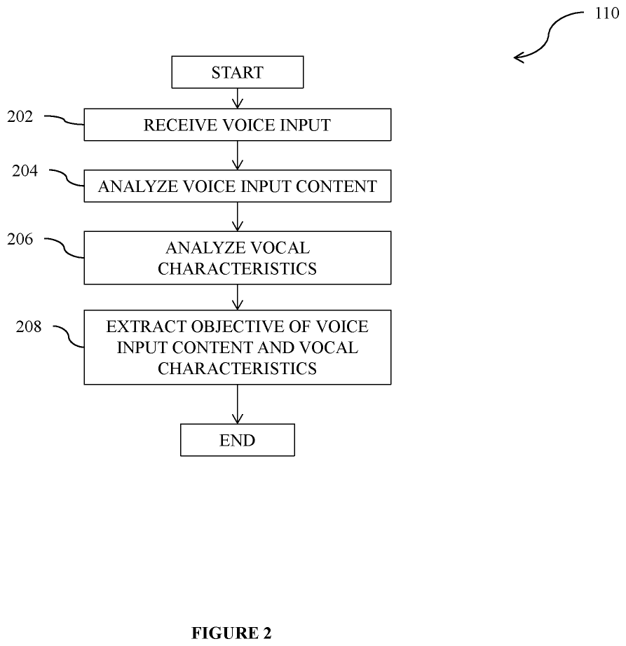

FIG. 2 is a schematic of a method of extracting objectives from a voice input.

Translation engine 110 receives voice input (step 202).

It is contemplated that voice input can include an actual voice input or any other input that represents a communication. In a preferred embodiment, voice input is the actual voice communications of a user. Alternatively, voice inputs can include, but are not limited, text input, visual communication inputs, sign language inputs, or any other form of communicative expression.

It is further contemplated that voice input can be received using any communication medium available in the art. For example, computing device 104 as depicted in FIG. 1 can include, but are not limited to, smart phones, laptop computers, tablet computers, microphones, an any other computing devices capable of receiving a communicative expression. It is further contemplated that the voice input can be transmitted to any one or more components of the distributed data processing environment depicted in FIG. 1.

In one embodiment, translation engine 110 receives a voice input from a user through a personal computing device. In this embodiment, it is contemplated that a user can interface with translation engine 110 via user interface 106. For example, a user can access translation engine 110 through a smart phone application and manipulate one or more parameters associated with translation engine 110. However, computing device 104 may not have a user interface, and the user may be limited to submitting voice input without any additional control via user interface 106 or any other user input interface.

In an alternative embodiment, translation engine 110 can receive a text input from a user through computing device 104. Based on the content of the message and any other indicators of the intent of the message (e.g., commas, exclamation points, and question marks), translation engine 110 process any translations with additional context provided by the other indicators of intent.

Translation engine 110 analyzes the content of the voice input (step 204).

The content of the voice input can include any objective characteristics of the voice input. For example, translation engine 110 can analyze the words spoken by a user. In another example, translation engine 110 can analyze the length of the voice input.

In alternative embodiment, the voice input can be an alternative input, such as a text-based or sign-based input. For example, translation engine 110 can translate text written by user from one language to another. In another example, translation engine 110 can be coupled to a camera to translate sign language to a different language and/or the same language in a different form (e.g., American Sign Language to spoken English).

In a preferred embodiment, translation engine 110 analyzes the words spoken by the user and the meaning behind the words. For example, translation engine 110 can analyze a Chinese language voice input and derive the literal meaning of the voice input based on a direct translation of the words spoken by additionally analyzing the intonation and the pacing of the words.

It is further contemplated that translation engine 110 can differentiate between non-communicative sounds in the voice input and actual language. For example, translation engine 110 can identify place holder words, such as “and like”, used in a voice input and omit those words in deriving the meaning of the voice input.

In another embodiment, translation engine 110 can use machine learning techniques to determine the objective of the voice input specific to a user. For example, translation engine 110 can use a supervised learning classifier to determine which combination of words, pacing, tone, and any other relevant vocal characteristics are associated with sarcasm for a particular user. In a more specific example, translation engine 110 can analyze the vocal characteristics associated with the phrase “I totally hate you.” to determine that the phrase is sarcastic rather than a serious expression of hatred.

In another example, translation engine 110 can use a time series classifier to extract user trends with voice inputs to determine that the particular phrase “Let's grab a drink” refers to non-alcoholic beverages prior to 6:00 PM and alcoholic drinks after 6:00 PM.

Translation engine 110 analyzes the vocal characteristics of the voice input (step 206).

Vocal characteristics can include, but are not limited to, any identifiable characteristics associated with the voice input. For example, vocal characteristics can include intonation, pacing, pitch, and volume.

Vocal characteristics are analyzed based on the language and culture of the voice input. Translations of the voice input are synthesized based on the corresponding vocal characteristics based on the language and culture of the voice output. Vocal characteristics can be defined in any manner available in the art. For example, vocal characteristics can be mined from public databases, taken from private databases, and/or inputted directly by a user to translation engine 110 via a user interface.

In one embodiment, translation engine 110 analyzes a sound-based voice input based on the intonation, pacing, pitch, and volume of the voice input.

For example, translation engine 110 can determine that a voice input from a menacing user has a rising intonation, a lower pitch, a slower speech rate, and increasing loudness over time. In another example, translation engine 110 can determine that a voice input from a ten-year-old child has a constant intonation, a higher pitch, a faster speech rate, and consistent loudness over time. In yet another example, translation engine 110 can determine that a voice input from a scared user has a wavering intonation, a higher pitch, a faster speech rate, an increasing number of irregular pauses over time, and a consistent quietness in the voice input.

In another embodiment, translation engine 110 analyzes a text-based voice input based on the content of the message, the punctuations, pictographs, symbols, and the structure of the text.

For example, translation engine 110 can determine that a short message service (SMS) text message includes a few sentences ending in exclamation points, a smiling emoji, and words indicating happiness about a particular event. In another example, translation engine 110 can determine that an email-based message includes proper language, long form paragraphs, and business jargon.

In yet another embodiment, translation engine 110 analyzes a visual voice input (e.g., sign language) based on the content of the message, the pacing, and the body language of the speaker.

For example, translation engine 110 can analyze sign language and determine that the message includes motivational words, consistent pacing, and non-exaggerated motions. In another example, translation engine 110 can analyze sign language and determine that the message follows a rhythmic pacing, words associated with struggle, and large, exaggerated motions.

Translation engine 110 extracts one or more objectives associated with the voice input content and vocal characteristics (step 208).

Objectives can include any purpose behind the message. For example, objectives can be extracted based on the content of the message, characteristics of the message recipient, and the auditory characteristics of the message.

In one embodiment, translation engine 110 extracts one or more objectives associated with a verbal input with associated vocal characteristics. Continuing a first example in step 206, translation engine 110 can determine that the voice input from the ten-year-old child has the objective of explaining an exciting occurrence during the child's school day. Continuing a second example in step 206, translation engine 110 can determine that the voice input and characteristics of the scared user have the objective of conveying a warning about a hazard and requesting assistance regarding the hazard.

In other embodiments, translation engine 110 extracts one or more objectives associated with a text-based input with associated vocal characteristics in text form. Continuing a first example in step 206, translation engine 110 can determine that the text message has the objective of conveying happiness and excitement about a forthcoming family vacation. Continuing a second example in step 206, translation engine 110 can determine that the email has the objective of confirming plans for a meeting to discuss a potential merger between two large corporations.

In yet other embodiments, translation engine 110 extracts one or more objectives associated with visual voice inputs. Continuing a first example in step 206, translation engine 110 can determine that the sign language including motivational words has the objective of offering support for individuals who have recently lost their ability to speak. Continuing a second example in step 206, translation engine 110 can determine that the sign language with rhythmic pacing has the objective of translating the lyrics of a rap performer into sign language for a deaf audience.

In some embodiments, translation engine 110 directly asks the user a questions or requests user input for a voice input. For example, translation engine 110 can directly ask a user whether the statement that they just said was sarcastic. In another example, translation engine 110 can ask the user what the context of their statement will be prior to the user providing a voice input.

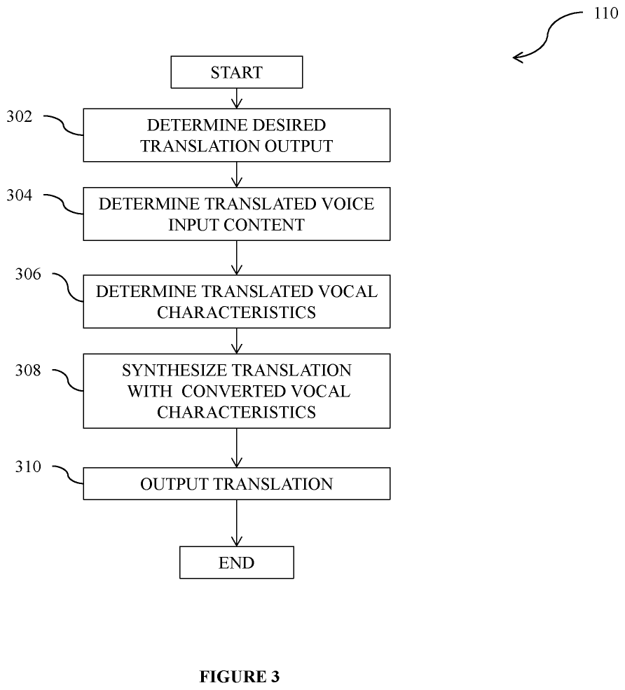

FIG. 3 depicts a method for translating a voice input and extracted objectives to a different language with different vocal characteristics.

Translation engine 110 determines a desired translation output (step 302).

A desired translation output can comprise any one or more expressions of the voice input and extracted objectives in a different form. For example, a desired translation output can be any one or more of a language, a physical expression (i.e., sign language), a picture, and a text-based message.

The desired translation output can be determined manually and/or automatically. For example, translation engine 110 can automatically detect the voices of an American woman and a Japanese man and, thereby, determine that the desired translation output will be English-to-Japanese and vice versa.

Translation engine 110 determines translated voice input content (step 304).

Translated voice input content can comprise translations in any translation medium. For example, translation mediums can include text-based translations, speech-based translations, and pictographic translations. In an exemplary embodiment, translated voice input content is a language translation from one language to another, different language. For example, translated voice input content can be a translation of the phrase “Why is my order delayed?” into the equivalent phrase in Russian.

Translated voice input content is not always a direct translation. In situations where a literal translation does not make sense in a particular language, translation engine 110 can determine an equivalent phrase. For example, the idiom “It's raining cats and dogs,” which is understandable as an idiom in English can be translated to “It is raining very heavily” in Japanese. In another example, the phrase “He's a know-it-all” in American English can be translated to “He's a know-all” when translated to British English.

Translation engine 110 determines translated vocal characteristics (step 306).

Translated vocal characteristics can comprise any vocal characteristics specific to the translated language that are used to help convey a message. It is further contemplated that the translated vocal characteristics are specific to the cultural background associated with the translation.

Vocal characteristics associated with particular emotions may not directly correlate between cultures.

In one embodiment, translation engine 110 converts a voice input and associated vocal characteristics to a translation with different vocal characteristics than the original voice input to maintain a consistent message.

For example, a phrase spoken in anger in a first language can be inputted as the phrase “I'm so angry!” with a rising inflection, a higher average volume, and a higher in pitch over time.

Though the voice input and vocal characteristics might indicate anger in a first culture associated with the original voice input, the vocal characteristics of the first culture may not align with the intended message in a second culture. The same emotions may be conveyed via different vocal characteristics depending on the culture. For example, anger may be expressed with a higher volume and ascending pitch in the first culture, but expressed in a lower volume, lower pitch, and descending pitch over time in the second culture.

As such, translation engine 110 can advantageously convert the vocal characteristics of the translated phrase to better reflect the message intended by the original phrase. Translation engine 110 can apply the converted vocal characteristics to the translated phrase to convey anger in the second culture.

Translation engine 110 synthesizes a translation with converted vocal characteristics (step 308).

Translation engine 110 synthesizes the translation using the converted voice input content and applying translated vocal characteristics to convey the original meaning of the voice input content and context.

Translation engine 110 outputs a translation (step 310).

Objectives can comprise any combination of characteristics that convey meaning

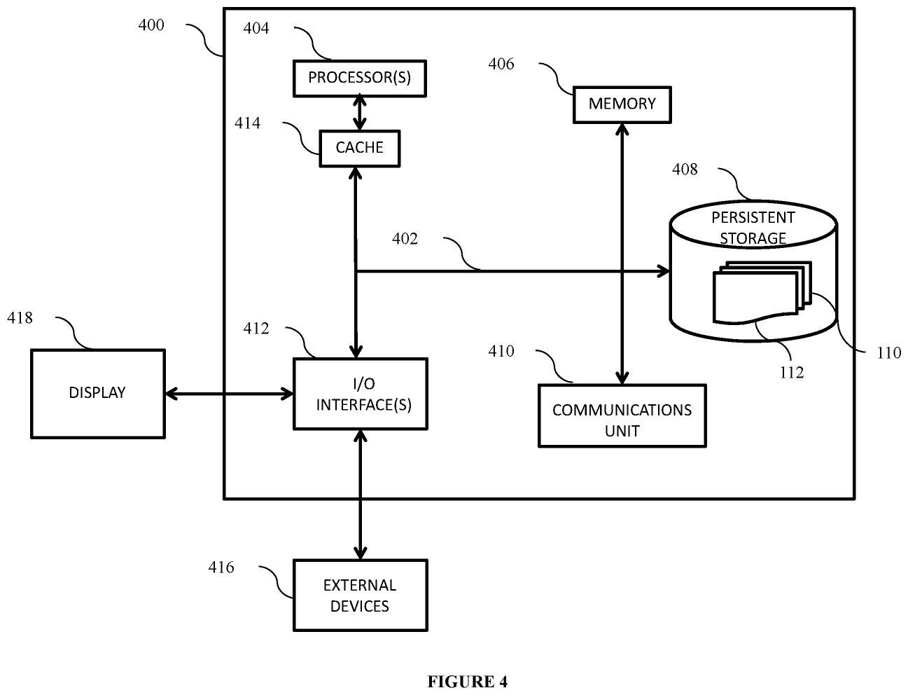

FIG. 4 depicts a block diagram of components of the server computer executing translation engine 110 within the distributed data processing environment of FIG. 1.

FIG. 4 is not limited to the depicted embodiment. Any modification known in the art can be made to the depicted embodiment.

In one embodiment, the computer includes processor(s) 404, cache 414, memory 406, persistent storage 408, communications unit 410, input/output (I/O) interface(s) 412, and communications fabric 402.

Communications fabric 402 provides a communication medium between cache 414, memory 406, persistent storage 408, communications unit 410, and I/O interface 412. Communications fabric 402 can include any means of moving data and/or control information between computer processors, system memory, peripheral devices, and any other hardware components.

Memory 406 and persistent storage 408 are computer readable storage media. As depicted, memory 406 can include any volatile or non-volatile computer storage media. For example, volatile memory can include dynamic random access memory and/or static random access memory. In another example, non-volatile memory can include hard disk drives, solid state drives, semiconductor storage devices, a read-only memory (ROM), an erasable programmable read-only memory (EPROM), a flash memory, and any other storage medium that does not require a constant source of power to retain data.

In one embodiment, memory 406 and persistent storage 408 are random access memory and a hard drive hardwired to held camera 104, respectively. For example, held camera 104 can be a computer executing the program instructions of translation engine 110 communicatively coupled to a solid state drive and DRAM.

In some embodiments, persistent storage 408 is removable. For example, persistent storage 408 can be a thumb drive or a card with embedded integrated circuits.

Communications unit 410 provides a medium for communicating with other data processing systems or devices, including data resources used by held camera 104. For example, communications unit 410 can comprise multiple network interface cards. In another example, communications unit 410 can comprise physical and/or wireless communication links.

It is contemplated that translation engine 110, database 112, and any other programs can be downloaded to persistent storage 408 using communications unit 410.

In a preferred embodiment, communications unit 410 comprises a global positioning satellite (GPS) device, a cellular data network communications device, and short to intermediate distance communications device (e.g., Bluetooth, near-field communications, etc.). It is contemplated that communications unit 410 allows held camera 104 to communicate with other computing devices 104 associated with other users.

Display 418 is contemplated to provide a mechanism to display information from translation engine 110 through held camera 104. In preferred embodiments, display 418 can have additional functionalities. For example, display 418 can be a pressure-based touch screen or a capacitive touch screen.

In yet other embodiments, display 418 can be any combination of sensory output devices, such as, for example, a speaker that communicates information to a user and/or a vibration/haptic feedback mechanism. For example, display 418 can be a combination of a touch screen in the dashboard of a car, a voice command-based communication system, and a vibrating bracelet worn by a user to communicate information through a series of vibrations.

It is contemplated that display 418 does not need to be physically hardwired components and can, instead, be a collection of different devices that cooperatively communicate information to a user.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of translating content and meaning of a voice input in a first language into a second language, comprising:
receiving the voice input in the first language;
determining voice input content;
analyzing vocal characteristics of the voice input;
extracting an objective of the voice input content and the vocal characteristics;
determining a second set of vocal characteristics associated with a second language that achieves the objective; and
translating the voice input content and the vocal characteristics of the first language to output a translation.

2. The method of claim 1, wherein determining the voice input content further comprises translating the literal meaning of the voice input content.

3. The method of claim 1, wherein the vocal characteristics are associated with one or more emotions.

4. The method of claim 1, further comprising receiving a desired translation output.

5. The method of claim 1, wherein extracting the objective of the voice input comprises requesting direct user input identifying, at least partially, the objective of the voice input.
